(19) United States
(12) Patent Application Publication
(10) Pub. No.: US 2003/0189075 A1
(43) Pub. Date: Oct. 9, 2003

(54) Load carrier having a tray including an exchangeable insert

(75) Inventors: John Laverack, Southbury, CT (US); Gregor G. Weaver, Seymour, CT (US)

Correspondence Address: HOWREY SIMON ARNOLD & WHITE LLP, 1299 PENNSYLVANIA AVE., NW, BOX 34, WASHINGTON, DC, 20004, US

(73) Assignee: Thule Sweden AB, Hillerstorp (SE)

(21) Appl. No.: 10/063,289

(22) Filed: Apr. 9, 2002

(51) Int. Cl. B60R 7/00; B60R 9/00; B60R 11/00

(52) U.S. Cl. 224/571; 224/924

(57) ABSTRACT

Display arrangement for a vehicular load carrier having at least a portion that is visible to an observer when installed upon a carrying vehicle. The arrangement includes a receiver that is configured to exchangeably accept an appearance-customizing insert. The display surface is configured to be exposed for visual observation by an onlooker when the insert is installed in the receiver. The receiver takes the form of an elongate track defined in at a side wall of the wheel tray. An interior space of the track forms a channel, the channel being configured to slidingly accept the insert. The channel has an access opening through which the insert is installable, the access opening being located at an end of the wheel tray. The interior space of the channel is at least partially defined by an overhang, the overhang configured to receive a portion of the insert thereunder to retain the insert and being shaped as U-shaped hook. From a manufacturing perspective, the hook can be an integrally formed portion of the tray; preferably, at a side wall thereof.

### BACKGROUND OF INVENTION

1. Field of the Invention

The present invention relates generally to a load carrier for a transporting vehicle. More specifically, the present invention relates to a load carrier having an elongate component, typified as a wheel tray, that includes an exchangeable insert accommodated in a receiver of the tray. The exchangeable insert permits the appearance of the tray, and in turn the load carrier, to be visually customized.

2. Backgroung of the Invention

Conventional vehicular load carriers such as those for bicycles, kayak/canoes, skis, snowboards, luggage and other types of cargo are typically manufactured so that the carrier is of one or more predetermined colors and/or has one or more predetermined finishes when supplied to the user/customer. The appearance of exposed surfaces of such conventional load carriers is normally factory-fixed before sale to the end user, for example, by painting, anodization, and/or application of customizing decals to a surface of the load carrier. For example, a conventional roof-top bicycle carrier typically includes a tray, referred to as a wheel tray, configured for securing and carrying a wheel of a bicycle. Common “looks” for such wheel trays are brushed metallic and paint-black. Though infrequently used, the only real viable means by which a distributor or an end user can customize the appearance of the wheel tray is by painting or applying decals to the exposed surface (s). These solutions, however, typically result in a relatively permanent change in appearance that lacks factory-controlled quality and appearance characteristics. Still further, for a distributor, certain treatments may not sell and the entire cost of the component establishes a carrying charge while in inventory. Moreover, this altered product is likely now non-returnable to the manufacturer and may have to be re-treated for sale or discarded if re-treatment is not feasible.

Thus, what is needed is a load carrier, such as a roof-top bicycle carrier, having an elongate component such as a tray that accepts an exchangeable insert, the exchangeable insert permitting the appearance of the tray, and in turn the load carrier, to be customized. The exchangeable insert should permit the appearance of the tray and the load carrier to be changed simply, inexpensively, and as frequently as desired.

### SUMMARY OF INVENTION

The present invention provides a load carrier having at least one component that is configured to accommodate installation of an exchangeable insert for adapting or customizing the appearance of the including carrier. Advantageously, the exchangeable insert(s) permits the appearance of the load carrier to be changed simply, inexpensively, and as frequently as desired by the operator.

In at least one embodiment, the present invention takes the form of a display arrangement for a vehicular load carrier. The arrangement has at least a portion that is visible to an observer when installed upon a carrying vehicle. The arrangement includes a receiver that is configured to exchangeably accept an appearance-customizing insert. While this aspect of a specially adapted receiver is alone considered to constitute an invention, for full user implementation, an appearance-customizing insert having a display surface of certain desired appearance is also contemplated. The display surface of the insert is configured to be exposed for visual observation by an onlooker when the insert is installed in the receiver.

In one embodiment, and as shown, the incorporating carrier takes the form of a bicycle carrier, exemplarily roof-mountable on a carrying vehicle, and includes a bicycle wheel tray. The receiver of the display arrangement takes the form of an elongate track defined at a side wall of the wheel tray. The formation of the track “at” the side wall of the wheel tray is described in this manner because it is contemplated that the track maybe formed either in a body of the tray, on the body of the tray, or suitably coupled to the tray for performing its requisite function. Preferably, the location of the track is at an exposed position on a side wall of the tray. It is also desirable that a track be provided on each of two lateral sides of the tray. In this manner, the tray can be displayed at either side of the carrying vehicle without being completely reoriented on a rack assembly of the carrying vehicle. Instead, when mounted on cross bars of the rack system, the tray can merely be loosened on the cross bars and slid across the vehicle to the other side thereby exposing the second and opposingly oriented insert on the opposite side of the tray.

An interior space of the track forms a channel, the channel being configured to slidingly accept the insert. The channel has an access opening through which the insert is installable, the access opening being located at an end of the wheel tray. The interior space of the channel is at least partially defined by an overhang, the overhang configured to receive a portion of the insert thereunder and arranged to retain the insert in the channel. Exemplarily, the overhang takes the form of a substantially U-shaped hook. From a manufacturing perspective, the hook can be an integrally formed portion of the tray; preferably, at a side wall thereof. As illustrated, two substantially U-shaped hooks are incorporated; one being substantially downwardly open and the other being substantially upwardly open.

When the receiver is formed in an elongate member, exemplarily a wheel tray, the insert correspondingly takes the form of an elongate strip. In at least one embodiment, the sole function of the insert is to customize the appearance of an incorporating tray. Preferably the strip is constructed from pliant material. With respect to the degree of pliability, the material of construction should be sufficiently flexible to allow, during installation of the elongate strip into the track, an uninstalled portion of the elongate strip to flex into a longitudinally curved configuration while an installed portion of the elongate strip in the track is substantially longitudinally straight in configuration.

The purpose of the display surface is to visually complement either or both of the incorporating carrier arrangement and the carrying vehicle upon which the entire assembly is, or is intended to be mounted. In this vein, the appearance of the display surface maybe contrasting, matching, or blended with respect to its finish and color.

In another aspect, a collection including a plurality of customizing inserts may be provided. Each insert of the collection advantageously has a differently appearing display surface thereby enabling a user to select a particular insert from the collection for achieving a desired appearance of the display arrangement. It is expected that the collection of inserts may be made available at the retailer and the user selects one at the point of purchase, or if the user desires a variable appearance after purchase, that individual user may purchase a collection of inserts for exchangeable use in the arrangement.

### BRIEF DESCRIPTION OF DRAWINGS

FIG. 1 is a perspective a view of an article load carrier mountable upon a carrying vehicle and taking the form of a bicycle carrier having an elongate component, illustrated as a wheel tray, with a bicycle carried therein.

FIG. 2 is a perspective view of an alternatively configured article load carrier in which an abbreviated elongate component of the carrier is configured to receive an elongate member of a carried article; in the illustration, the article is a bicycle supported at one of its frame members.

FIG. 3 is an end elevational view of an exemplary wheel tray operable for receiving an exchangeable insert in accordance with one embodiment of the present invention;

FIG. 4 is a top plan view of the wheel tray of FIG. 3;

FIG. 5 is a side elevational view of the wheel tray of FIG. 3;

FIG. 6 is an end elevational view of an exemplary appearance-customizing exchangeable insert operable for engaging a wheel tray such as that illustrated in FIG. 3; and

FIG. 7 is a side elevational view of the insert of FIG. 6.

### DETAILED DESCRIPTION

As required, detailed embodiments of the present invention(s) are disclosed herein; however, it is to be understood that the disclosed embodiments are merely exemplary of the invention(s) that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Certain terminology will be used in the following description for convenience and reference only and will not be limiting. For example, the words “rightwardly”, “leftwardly”, “upwardly” and “downwardly” will refer to directions in the drawings to which reference is made. The words “inwardly” and “outwardly” refer to directions toward and away from, respectively, the geometric center of the structure being referred to. This terminology includes these words, specifically mentioned derivatives thereof, and words of similar import.

Furthermore, elements may be recited as being “coupled”; when such terminology is used, it is anticipated that the elements may be connected together in such a way that there may be other components interstitially located between the connected elements or that the elements may be connected in fixed or movable relation one to the other. The descriptor “substantially” is used to indicate that a structure which is so qualified can include deviations that do not alter the functionality of the components described in this manner.

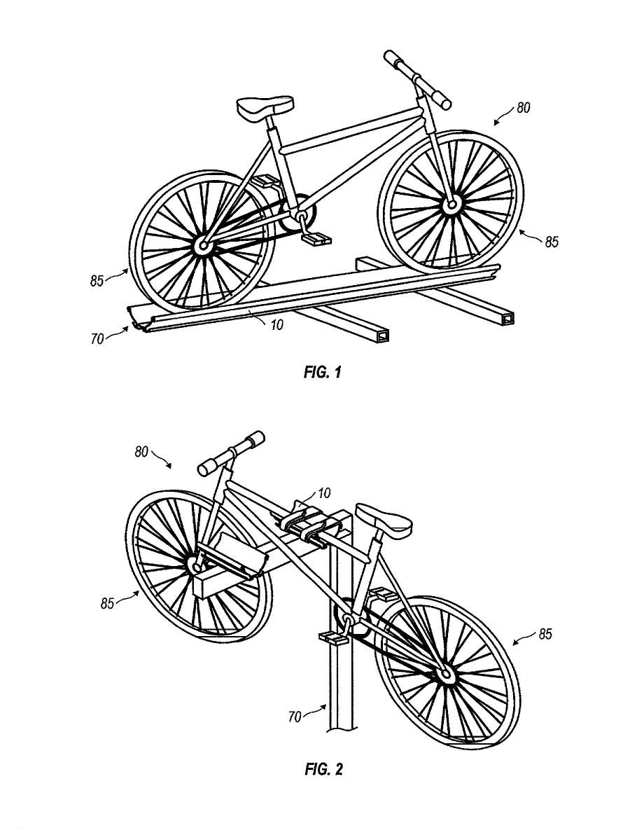

Referring to the accompanying drawings, FIG. 1 provides a perspective view of a vehicular load carrier 70 configured to be mounted to a carrying vehicle. The vehicle is not shown, but it will be appreciated by those skilled in the art that the carrier 70 can be mounted about a vehicle at various locations. Two primary locations, however, include atop the roof and at the rear of the vehicle. As illustrated in FIG. 1, the load carrier 70 is configured as a bicycle carrier 70 having an elongate component 10 in the form of a wheel tray 10 designed to accept, in this illustrated case, both tires 85 of a bicycle 80. It should be appreciated, however, that the wheel tray 10 may be shorter and suitable for accommodating only a single bicycle tire 85 and still constitute an elongate component 10 of the carrier 70. In this same vein, FIG. 2 illustrates an alternative embodiment of the load carrier 70 in which the elongate component 10 of the carrier 70 is a tray-type structure adapted to receive a portion of the article 80 to be carried, such as the bicycle frame member as shown.

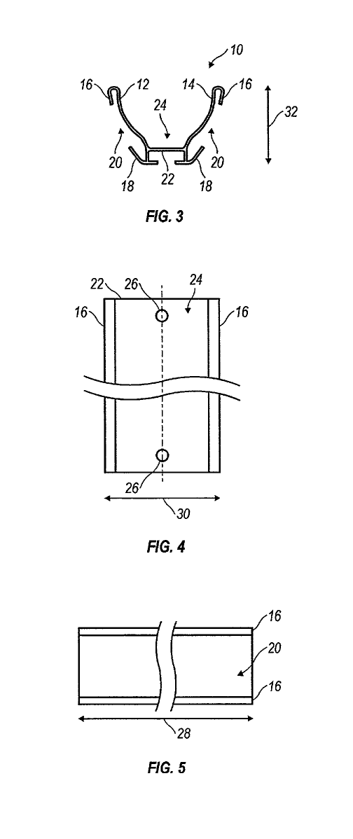

Referring to FIGS. 3-5, an exemplary wheel tray 10 operable for receiving an appearance-customizing and exchangeable insert in accordance with an embodiment of the present invention is illustrated. The following detailed description is directed towards an exemplary wheel tray 10 adapted to receive an exchangeable insert 40, however the present invention is not limited to this exemplary wheel tray 10. The exchangeable inserts 40 can be used with load carriers 70 otherwise configured, but still capable of receiving such an insert 40. As shown, the wheel tray 10 of FIG. 1 is operable for securing and carrying a wheel 85 of a bicycle 80. At least one, and preferably two, elongate tracks are provided exteriorly at the wheel tray 10. In the instance of two tracks, one is located on each side of the tray 10. Each track includes a first curved portion 12 and a second curved portion 14. The first curved portion 12 and the second curved portion 14 each include a hook portion 16 and a shelf portion 18, forming a main channel with a pair of side insertion channels 20 operable for receiving an exchangeable insert 40. The first curved portion 12 is joined to the second curved portion 14 by a cross-member 22 establishing the receiver 24 for a wheel 85 or otherwise configured member of an article to be carried thereupon. In a preferred embodiment, the receiver 24 is operable for securing and carrying the wheel 85 of the bicycle 80. Optionally, the cross-member 22 can include a plurality of holes 26 for weight reduction, water drainage, and the like.

The constituent components or portions of the wheel tray 10 can be made of metal, plastic, and other suitable materials of construction. For example, the components of the wheel tray 10 can be made of an extruded aluminum alloy and provided with an anodized or black powder paint finish. Other materials and finishes well known to those of ordinary skill in the art can also be utilized. A length 28 of the wheel tray 10 can range from just a few inches to as much or more than seventy-five inches. The width 30 of the wheel tray 10 is variable, but typically falls between one and two inches. Other dimensions can be utilized, as necessary, for accommodating variously configured bicycles 80 and their tire-and-wheel 85 combinations.

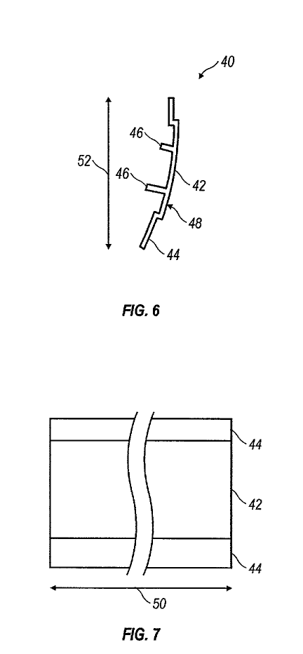

Referring to FIGS. 6-7, an exemplary exchangeable insert 40 operable for engaging the wheel tray in accordance with an embodiment of the present invention is illustrated. As shown, the exchangeable insert 40 of the present invention includes a center portion 42, a pair of end portions 44, and a pair of legs 46. The end portions 44 of the exchangeable insert 40 are operable for slidingly engaging the hook 16 and shelf portions 18 of the wheel tray 10 shown in FIGS. 1. The legs 46 of the exchangeable insert 40 are operable for applying pressure toward the curved portions 12 and 14 of the wheel tray 10, and supporting and providing rigidity to the center portion 42 of the exchangeable insert 40. In the illustrated embodiment, a pair of legs 46 are utilized, however, one or more legs 46 can be utilized. The components of the exchangeable insert 40 are disposed within the insertion channels 20 of the wheel tray 10, the center portion 42 of the exchangeable insert 40 being outwardly visible.

The components of the exchangeable insert 40 can be made of plastic, metal, and like suitable materials of construction. Preferably, the exchangeable insert 40 is constructed from a pliable material such as plastic so that a certain degree of flexibility is enabled in the insert 40. It should be appreciated, however, that if a pliable insert 40 is chosen, flexibility will typically be desired along a lengthwise axis thereof, and reinforcements, exemplarily in the form of ribs, may be incorporated for resisting flexure in directions substantially transverse thereto. For example, the components of the exchangeable insert 40 can be made of plastic of a predetermined color with a logo, a decal, or printed material applied to an exposed surface 48 of the center portion 42 of the exchangeable insert 40. Other suitable materials and finishes which will be recognized by persons skilled in the art can also be utilized without departing from the spirit of the invention. The length 50 and height 52 of the insert 40 is selected for compatibility with the dimensions of the carrier component, exemplarily a wheel tray 10 into which the insert 40 is to be installed. Optionally, the exchangeable insert 40 may be curvatiously configured or may be formed to be substantially flat across its width. Other dimensions and curvatures can be utilized, as necessary, and as the environment in which the insert 40 is going to be incorporated varies.

As described above, the exchangeable insert 40 is preferably operable for slidingly engaging the insertion channel(s) 20 of the wheel tray 10; with the center portion 42 of the exchangeable insert 40, optionally including an outwardly directed logo or decal. In this manner, the appearance of the wheel tray 10 and the load carrier can be customized. Alternatively, the exchangeable insert 40 can be resiliently pliable and configured to snap into the insertion channels 20 of the wheel tray 10, engaging the hook portions 16 and the shelf portions 18 of the wheel tray 10. Because insertion channels 20 are included on both sides of the wheel tray 10, the exchangeable insert 40 can be utilized to customize the outward appearance of the roof-top carrier whether the wheel tray 10 is currently positioned on the driver-side of a transporting vehicle or on the passenger-side of a transporting vehicle.

Although the present invention has been described with reference to preferred embodiments and examples thereof, other embodiments and examples can achieve the same or similar results. For example, the present invention has been described with reference to a bicycle carrier having a wheel tray. The present invention, however, can also be adapted to be utilized with other types of load carriers, with or without trays. The following claims are intended to cover all such equivalent embodiments and examples.

1. A display arrangement for a vehicular load carrier, a portion of the arrangement being visible to an observer when installed upon a carrying vehicle, said arrangement comprising:
an elongate component of a vehicular load carrier, said elongate component including a receiver configured to exchangeably accept an appearance-customizing insert.

2. The display arrangement as recited in claim 1, further comprising:
an appearance-customizing insert having a display surface, said display surface configured to be exposed for visual observation when said insert is installed in said receiver.

3. The display arrangement as recited in claim 2, further comprising:
said receiver being an elongate track defined in a side wall of a wheel tray of a vehicular load carrier.

4. The display arrangement as recited in claim 2, further comprising:
said receiver being an elongate track defined at a side wall of a wheel tray of a vehicular load carrier.

5. The display arrangement as recited in claim 4, further comprising:
an interior space of said track forming a channel, said channel being configured to slidingly accept said insert.

6. The display arrangement as recited in claim 5, further comprising:
said channel having an access opening through which said insert is installable, said access opening being located at an end of said wheel tray.

7. The display arrangement as recited in claim 5, further comprising:
said interior space of said channel being at least partially defined by an overhang, said overhang configured to receive a portion of said insert thereunder for retaining said insert in said channel.

8. The display arrangement as recited in claim 7, further comprising:
said overhang being a substantially U-shaped hook.

9. The display arrangement as recited in claim 8, further comprising:
said substantially U-shaped hook being an integrally formed portion of said tray.

10. The display arrangement as recited in claim 8, further comprising:
said substantially U-shaped hook being substantially downwardly open when said tray is installed upon a roof-top of a carrying vehicle.

11. The display arrangement as recited in claim 8, further comprising:
said substantially U-shaped hook being substantially upwardly open when said tray is installed upon a roof-top of a carrying vehicle.

12. The display arrangement as recited in claim 4, further comprising:
said insert being an elongate strip constructed from pliant material, said pliant material being sufficiently flexible to allow, during installation of said elongate strip into said track, an uninstalled portion of said elongate strip to flex into a longitudinally curved configuration while an installed portion of said elongate strip is substantially longitudinally straight in configuration.

13. The display arrangement as recited in claim 4, further comprising:
said display surface of said insert being finished to contrast with a surrounding portion of said wheel tray.

14. The display arrangement as recited in claim 4, further comprising:
said display surface of said insert being finished to match a surrounding portion of said wheel tray.

15. The display arrangement as recited in claim 4, further comprising:
said display surface of said insert being finished to complement a surrounding portion of said wheel tray.

16. The display arrangement as recited in claim 15, further comprising:
said display surface of said insert being colored to contrast with a surrounding portion of said wheel tray.

17. The display arrangement as recited in claim 15, further comprising:
said display surface of said insert being colored to match a surrounding portion of said wheel tray.

18. The,display arrangement as recited in claim 4, further comprising:
said display surface of said insert being finished to complement an exterior finish of a carrying vehicle of a vehicular carrier into which said display arrangement is incorporated.

19. The display arrangement as recited in claim 18, further comprising:
said display surface of said insert being finished to contrast with an exterior finish of a carrying vehicle of a vehicular carrier into which said display arrangement is incorporated.

20. The display arrangement as recited in claim 18, further comprising:
said display surface of said insert being finished to match with an exterior finish of a carrying vehicle of a vehicular carrier into which said display arrangement is incorporated.

21. The display arrangement as recited in claim 4, further comprising:
said display surface of said insert being colored to complement an exterior finish of a carrying vehicle of a vehicular carrier into which said display arrangement is incorporated.

22. The display arrangement as recited in claim 21, further comprising:
said display surface of said insert being colored to contrast with an exterior finish of a carrying vehicle of a vehicular carrier into which said display arrangement is incorporated.

23. The display arrangement as recited in claim 21, further comprising:
said display surface of said insert being colored to match with an exterior finish of a carrying vehicle of a vehicular carrier into which said display arrangement is incorporated.

24. The display arrangement as recited in claim 4, further comprising:
a collection including a plurality of customizing inserts, each insert of said collection having a differently appearing display surface thereby enabling a user to select a particular insert from said collection for achieving a desired appearance of said display arrangement.

25. The display arrangement as recited in claim 4, further comprising:
said display surface of said insert being printed with identification of provider of at least a portion of said display arrangement.

26. The display arrangement as recited in claim 4, further comprising:
said display surface of said insert being treated to have a metallic appearance.

27. The display arrangement as recited in claim 4, further comprising:
said wheel tray configured to receive at least one bicycle wheel therein for carriage upon a transporting vehicle.
